(19) United States
(12) Patent Application Publication
(10) Pub. No.: US 2013/0268544 A1
(43) Pub. Date: Oct. 10, 2013

(54) AUTOMATIC FORMATION OF ITEM DESCRIPTION TAGS FOR MARKUP LANGUAGES

(71) Applicant: Andrey N. Nikankin, Sankt-Petersburg (RU)

(72) Inventor: Andrey N. Nikankin, Sankt-Petersburg (RU)

(73) Assignee: RAWLLIN INTERNATIONAL INC., Tortola (VG)

(21) Appl. No.: 13/442,580

(22) Filed: Apr. 9, 2012

(51) Int. Cl. G06F 17/30

(52) U.S. Cl. 707/754; 707/736; 707/E17.009

(57) ABSTRACT

System and methods are disclosed for employing a matrix that maps known terms to tag values based on pre-existing tag value assignments in order to automatically assign tags to item descriptions. In particular, the matrix maps terms to tags as a function of pre-existing associations between the terms and the tags in one or more external data sources. A term generation component receives a description comprising a plurality of terms and filters the description to identify a subset of the plurality of terms. A tag assignment component then identifies one or more tags associated with the subset of the plurality of terms in the data matrix and assigns the one or more tags to the description.

### TECHNICAL FIELD

This application generally relates to employing a matrix that maps known terms to tag values based on pre-existing tag value assignments in order to automatically assign tags to item descriptions.

### BACKGROUND

Meta tags, such as those for markup languages including hypertext markup language (HTML) and extensible markup language (XML), are often employed as description tags and keyword tags. Such description tags and keywords tag are not seen by users. Instead, these tags provide metadata to user agents, such as search engines. The metadata these tags provide helps to describe the information they are assigned to and allow the information to be found again by browsing and enabling keyword-based classification and search of the information. For example, catalogue items associated with a world wide web page often include descriptions to inform user's about attributes of the item. Often times, in order to facilitate searching and finding catalogue items using a browser, the items descriptions are assigned one or more tags. However, determining appropriate tags to assign to a description as well as manually assigning the tags to the description can be a time consuming and tedious process.

The above-described deficiencies associated with providing prompts associated with video content are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with automatically suggesting audio tracks for dubbing to media items. For instance, an embodiment includes a term generation component configured to receive a description comprising a plurality of terms and filter the description to identify a subset of the plurality of terms and a tag assignment component configured to identify one or more tags associated with the subset of the plurality of terms in a data matrix and assign the one or more tags to the description, wherein the data matrix maps terms to tags as a function of pre-existing associations between the terms and the tags in one or more external data sources. In an aspect, the term generation component is configured to filter the description as a function of a term type.

In another non-limiting embodiment, a method is provided, comprising receiving a description comprising a plurality of terms, filtering the description to identify a subset of the plurality of terms, identifying one or more tags associated with the subset of the plurality of terms in a data matrix, wherein the data matrix maps terms to tags as a function of pre-existing associations between the terms and the tags in one or more external data sources, and assigning the one or more tags to the description. In an aspect, the filtering comprises filtering the description as a function of a priority value associated with a term in the data matrix, wherein the data matrix further assigns priority values to the terms based in part on a total number of tags associated with the terms in the data matrix, wherein a lower number of associated tags equates to a higher tag priority value than a priority value associated with a number higher than the lower number.

Still, in yet another non-limiting embodiment, a computer-readable storage medium comprising computer-readable instructions is provided that, in response to execution, cause a computing system to perform operations, comprising filtering a description of an item associated with a content category, the description comprising a plurality of terms, determining a subset of terms from the plurality of terms based on the filtering, identifying one or more tags associated with the subset of the plurality of terms in a data matrix, wherein the data matrix maps terms to tags as a function of pre-existing associations between the terms and the tags in one or more external data sources with respect to the content category, and assigning the one or more tags to the description.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates an example non-limiting system for generating a matrix that maps terms to tag values in accordance with various aspects and implementations described herein;

FIG. 2 illustrates a diagram of an example data matrix in accordance with various aspects and implementations described herein;

FIG. 3 illustrates a diagram of an example matrix that has been updated in accordance with various aspects and implementations described herein;

FIG. 4 illustrates a diagram of an example matrix in accordance with various aspects and implementations described herein;

FIG. 5 illustrates a diagram of an example matrix that has been updated in accordance with various aspects and implementations described herein;

FIG. 6 illustrates a diagram of example matrices for one or more item description content categories in accordance with various aspects and implementations described herein;

FIG. 7 illustrates another example non-limiting system for generating a matrix that maps terms to tag values in accordance with various aspects and implementations described herein;

FIG. 8 illustrates another example non-limiting system for generating a matrix that maps terms to tag values in accordance with various aspects and implementations described herein;

FIG. 9 illustrates an example methodology for generating a matrix that maps terms to tag values in accordance with various aspects and implementations described herein;

FIG. 10 illustrates an example methodology for generating a matrix that maps terms to tag values in accordance with various aspects and implementations described herein;

FIG. 11 illustrates an example methodology for generating a matrix that maps terms to tag values in accordance with various aspects and implementations described herein;

FIG. 12 illustrates an example non-limiting system for automatically assigning tags to terms for an item description in accordance with various aspects and implementations described herein;

FIG. 13 illustrates an example methodology for automatically assigning tags to terms for an item description in accordance with various aspects and implementations described herein;.

FIG. 14 illustrates a block diagram representing exemplary non-limiting networked environments in which various non-limiting embodiments described herein can be implemented.

FIG. 15 illustrates a block diagram representing an exemplary non-limiting computing system or operating environment in which one or more aspects of various non-limiting embodiments described herein can be implemented.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

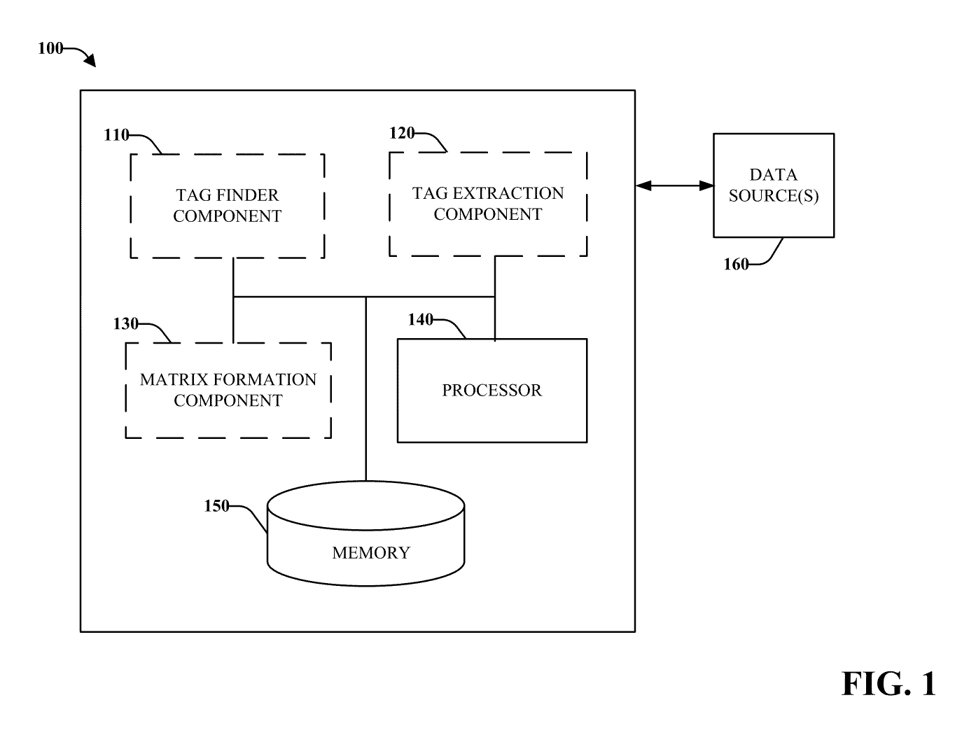

Referring now to the drawings, with reference initially to FIG. 1, presented is a system 100 than can facilitate generating a matrix that maps known terms to tag values based on pre-existing tag value assignments. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 150 for storing computer executable components and instructions. A processor 140 can facilitate operation of the computer executable components and instructions by the system 100.

System 100 is configured to configured to generate a matrix that maps known words or terms to one or more tags based on pre-existing tag assignments for the known terms in a similar context. The matrix can then later be employed to automatically determine tag assignments for new information that has not yet been tagged. A used herein, a tag a is a non-hierarchical keyword assigned to a piece of information (such as an Internet bookmark, a digital image, a computer file, and etc). With respect to digital information and documents or information formatted for rendering via cloud computing (e.g. the Internet), tags are provided as metadata. Tags can be employed to provide metadata for markup language documents, such as hypertext markup language (HTML), extensible markup language (XML), extensible hypertext markup language (XHTML). Such metadata is not displayed on a document page, but is machine parsable.

In an aspect, tags help to describe the information they are assigned to and allow the information to be found again by browsing and enabling keyword-based classification and search of the information. For example, catalogue items associated with a world wide web page often include descriptions to inform user's about attributes of the item. Often times, in order to facilitate searching and finding catalogue items using a browser, the items descriptions are assigned one or more tags.

In an embodiment, system 100 includes tag finder component 110, tag extraction component 120, and matrix formation component. The tag finder component 110 is configured to receive a term and query one or more networked data sources 160 to identify a usage of the term and one or more tags assigned to the term in association with the usage of the term. The tag extraction component 120 is configured to extract the one or more tags assigned to the term in association with the usage of the term. In turn, the matrix formation component 130 is configured to associate the one or more tags with the term in a data matrix.

The term data sources 160 is used to refer to an entity, service, or application that provides data, specifically tagged data. In an aspect, data sources include tagged data that is accessible via a network, (e.g. the Internet or an Intranet), and that is open to and parsable by system 100. There are many possible sources of data. For example, applications collect and maintain information in databases, organizations store data in the cloud, individuals produce personal data and store it locally, and many firms make a business out of selling data. In an aspect, a data source 160 includes numerous amounts of different types of data at a specific location. The specific location is generally identified by a uniform resource locator (URL). In general, data sources are identified by a uniform resource identifier (URI) that includes a specific URL and uniform resource name (URN). In an aspect, a data source 160 includes a service configured to expose its data and associated metadata (e.g. tags) using the Odata protocol.

It is noted that although the embodiments and examples will be illustrated with respect to an architecture employing HTML pages and the World Wide Web, the embodiments and examples may be practiced or otherwise implemented with any network architecture utilizing clients and servers, and with distributed architectures, such as but not limited to peer to peer systems.

In an embodiment, in order to build or generate a matrix, tag finder component 110 receives a term and then collects tags assigned to that term as employed by various data sources. In an aspect, the tag finder component can receive a machine generated term. In an another aspect, the tag finder component 110 can receive a term as manual input from a user (either directly or indirectly via a user device). In another aspect the tag finder component can receive the term from a term generation component 810 discussed infra. In an aspect, the term generation component 810 can provide the term finder component 110 with terms to collect tags for based on a list of terms provided to system 100 and stored in a data store (not shown) associated with system 100, such as a data store provided in memory 150. For example, memory 150 can include a list of all terms or words listed in an English dictionary. In another example, memory 150 can include a list of terms associated with a particular content category. For example, memory 150 can include a list of terms employed in movie description, a list a medical terms, a list of legal terms, a list of computer software related terms, and etc. Still in yet another aspect, the tag finder component 110 or the term generation component 810 can import term lists from an external data source. The tag finder component 110 can further be configured to parse through data sources to find one or more tags associated with each term in a given list.

Once a term is received, the tag finder component 110 queries one or more external data sources 160 an identify a usage of the term and one or more tags assigned to the term in association with the usage of the term. For example, the tag finder component 110 may take the term “vampire” and query a database of a data source 160 to determine if the term “vampire” is used or exists in the database. If the tag finder component 110 finds the term “vampire” in the database, the tag finder component 110 can further identify one or more tags assigned to the term “vampire” as metadata. For example, the database may have the word “vampire” yet it may not have an tags associated therewith. Yet in another example, the word “vampire” in the database may be associated with multiple tags such as “blood,” “dark,” and “fangs.” Tags can include any identifiable information including, words, number, codes, or characters.

Tags can include single words as well as word phrases made up of two or more words. For example, the words “outer” and “space” each individually be tags while the phrase “outer space” can also be a tag. In an aspect, the tag finder component 110 is configured to identify tags based on the structure of the tags with respect to the markup language employed to create the tags. For example, in HTML, meta keywords tags are applied to data using the following structure:

<META NAME=“keywords” CONTENT=“oranges, orange juice, lemons, limes”>. The keyword tags in the example above include “oranges,” “orange juice,” “lemons,” and “limes.” In an aspect, the tag finder component 110 can identify tags based on the structure of the markup language which applies commas to separate the individual tags. Thus in the above example, the phrase “orange juice” is treated as one tag, not two.

In an embodiment, the tag finder component 110 can query one or more data sources until it finds a usage of a term with one or more tags associated therewith. According to this embodiment, once the tag finder component 110 find an instance of usage of the term with associated tags, the tag finder component can stop querying data sources. However, in another embodiment, the tag finder component 110 is further configured to query multiple data sources for a usage of a term and/or multiple usages of a term within a single data source. For example, the tag finder component 110 may identify multiple usages of the term “vampire” in a data source that compiles movie descriptions. For instance, the data source may include over one hundred movie descriptions that include the term “vampire.” Similarly, multiple different data sources can include a usage of the term “vampire,” in movie descriptions or in other usage contexts. According to this example, for each of the usages of the term “vampire” in the movie descriptions, the tag finder component can identify one or more tags assigned to the term.

It can be appreciated that given a large amount of data available from a plurality of data sources, a single term may be used and associated with tags many times. Thus in an aspect, in order to conserve energy and resources expended conducting a query for a term, the tag finder component 110 can operate under parameters that restrict exhaustive querying of all sources available. For example, in an aspect, the tag finder component 110 can be configured to conduct a query for a predetermined duration of time. In another example, the tag finder component 110 can be configured to stop a query for a term once a predetermined number of different tags for the term have been identified or once an identification of a new tag (with respect to tags already identified for the term during a given query) for the term is not found within a predetermined timeframe.

In yet another embodiment, the tag finder component 110 is configured to continuously query data sources for a usage of a term and its associated tags. According to this aspect, the tag finder component 110 can search same sources repeatedly over time. Similarly, as new data sources are found or created, the tag finder component can identify potentially new tag assignments for the term in those new sources. Thus when a same source updates a tag assignment for a term or adds a new tag assignment for the term or when a new data source associated the term with tags, the tag finder component 110 can identify it and employ the tag information for updating the matrix. In an aspect, rather than continuously exploring a term, the tag finder component 110 can be configured to conduct a search for a usage of a term in a scheduled manner. For example, the tag finder component 110 may be configured to conduct a search for a same term (to facilitate updating the matrix), once a day, once a week, once a month, one a year, and etc.

In another aspect, the tag finder component 110 can be configured to query specific data sources based on quality reputation associated with the data sources. According to this aspect, memory 150 can store a list of reputable data sources, wherein the reputation of the data source is based on a general quality of tag assignment exhibited by the source. In an aspect, the data sources can be ordered in memory based on reputation. According to this aspect, the tag finder component 110 can query data sources in an order based on their respective reputation. For example, the tag finder component can start with a highest rated data source and continue with the next highest rated and so on. In an aspect, the data sources can be classified into categories of data content. For example, a data source that compiles information for movies or film can be classified as a “movie description term,” data source, or a data source that compiles information about pharmaceuticals can be classified as a “pharmaceutical terms,” data source. According to this aspect, the tag finder component 110 may further be configured to query data sources belonging to a specific classification.

As noted above, the tag finder component 110 queries one or more external data sources 160 and identify a usage of a specific term. It can be appreciated that a single term can be used in a variety of content based contexts. Depending on the context of usage, the tags assigned to the term may vary. For example, usage the term “chicken,” in a movie description context may return the tags “feathers,” “scared,” and “farm,” while usage of the term “chicken” in recipe description context may return the tags “grilled,” “fried,” or “baked.” Therefore, in an aspect, tag finder component 110 can be directed by system 100 to explore or query a term with respect to a type of usage of the term or with respect to usage of the term under a predefined content category. According to this aspect, the tag finder component 110 may limit its search to data sources falling into a specific content category as defined in memory or as identified by the tag finder component 110. Further, the tag finder component 110 can limit its search to data within the content category. For example, if the content category is “movie descriptions,” the tag finder component 110 can limit its search to data sources that fall into a category of data sources that provide movie descriptions. In addition, within those data sources, the tag finder component 110 can limit its search to data that is classified as a movie description. Thus any addition information provided by the data source aside from movie descriptions can be ignored by the tag finder component 110. In an aspect, the tag finder component 110 can employ metadata associated with searched data in order to identify a content category of the data.

Tag extraction component 120 extracts found tags assigned to a searched term in association with the usage of the term. As noted above, tags can be assigned to data as metadata written into a document or data object using a markup language such as HTML. In an aspect, tag extraction component 120 extracts found tags as written in the markup language employed by the data source. The extracted tags can further be stored in memory 150. In an aspect, the tag extraction component 120 extracts found tags for a term and stores the found tags in temporary memory while the tag finder component 110 continues to query for additional tag assignments for the term. For example, tag extraction component 120 can store found tags in cache memory which can later be accessed by matrix formation component for processing of the tags.

Matrix formation component 130 processes extracted tags for a terms to form a data matrix or information log that defines relationships between terms and tags. In an aspect, the matrix further defines relationships between terms and tags with respect to a pre-defined content usage category. In another aspect, the matrix formation component 130 forms multiple different matrices, each of which defining relationships between terms and tags with respect to a different pre-defined content usage category.

In general, in response to the extraction of one or more tags for a term, the matrix formation component 130 is configured to associate the one or more tags with the term in a data matrix. For example, the tag finder component 110 may find a usage of the term “vampire” in a data source that is assigned with the tags “blood,” “dark,” and “fangs.” The extraction component 120 can extract the three tags and store the three tags in memory (volatile or nonvolatile). The matrix formation component can then associated the three tags with the term vampire in a data matrix. The tag finder component can further query the one or more networked data sources to identify other usages of the term and one or more tags assigned to the term in association with the other usages of the term. For example, the tag finder component may search within a same data source to identify other usages of the term “vampire” within the data source and/or search additional data sources to find other usages of the term “vampire.” Each time the tag finder component 110 identifies a usage of the term “vampire” the tag extraction component 120 can extract the associated tags and store the tags in memory 150. In essence, the tag extraction component can collect all extracted tags for a term in temporary memory for processing by the matrix formation component 130.

The matrix formation component 130 is configured to associate extracted tags for a given term with the term in a data matrix. The matrix formation component 130 can store the matrix in memory 150. As used herein, a data matrix is a collection of terms and tags that defines relationships or associations between the terms and the tags. In an aspect, the matrix is a dynamic information source that continuously re-defines relationships between tags and terms in the matrix based on addition or deletion of new terms and tags. In an embodiment, the matrix formation component 130 can associate all found tags for a given term with the term in a data matrix. For example, as the tag finder component 110 queries within a plurality of data sources, it can be appreciated that for certain terms, a great number of tags may be identified as being associated therewith. For example, the term “vampire” may additionally be associated with tags such as “preternatural being,” “reanimated,” “corpse,” “suck,” “sleeping,” “night,” “folklore,” “undeparted soul,” “demon,” “burned,” “preys,” and etc. Accordingly, in each time the extraction component extracts a new tag for a given term, the matrix formation component can associate the new tag with the term in the data matrix.

In another aspect, the matrix formation component 110 can select a subset of tags from extracted tags to associate with a term in the data matrix. For example, the matrix formation component 130 may analyze the collection of extracted tags for a given term to identify a subset of the tags which the matrix formation component 110 determines as best representative or most descriptive of the term. In an aspect, in order to determine the subset, the matrix formation component 130 can apply a duplication rule, wherein duplicated tags are given priority over non-duplicated tags. According to this aspect the matrix formation component 130 is further configured to identify duplicated tags in the collection of found and extracted tags for a given term. The matrix formation component can further determine a set of distinctive tags based in part on a number of times a duplicated tag is duplicated, and associate the distinctive set of tags with the term in the data matrix. For example, with respect to the term “vampire,” the tag finder component may likely find that the tags “blood,” “dark,” and “fangs,” are often associated with the term “vampire.” For instance, the tag extraction component 120 may extract the terms “blood,” “dark,” and “fangs,” for the term “vampire,” over ten times a piece. Thus the matrix formation component can associate each of the terms “blood,” “dark,” and “fangs,” with a duplication number of ten for the term “vampire.”

In an aspect, the matrix formation component 130 can determine a minimum duplication number to tags prior to associating the tags with the term in the matrix. For example, the matrix formation component may determine the set of distinctive tags includes tags that have been duplicated at least twice. In another aspect, the matrix formation component can determine the set of distinctive tags as a function of a percentage of tags having highest duplication numbers. For example, the matrix formation component 130 may associate the top ten percent of tags having the highest duplication numbers with a term in the matrix, or associate the top ten tags with the highest duplication numbers with respect to the other tags, with the term in the matrix.

In another embodiment, the matrix formation component 130 is further configured to assign a term priority value to a term in the data matrix based in part on a total number of different tags associated with the term in the data matrix or based in part on a total number of different tags associated with the term in the data matrix with respect to other terms in the data matrix. According to this embodiment, the number of tags associated with a term inversely reflects a terms priority value. For example, in an aspect, the greater the number of tags associated with a term the lower its priority value. In other words, a lower number of associated tags equates to a higher term priority value than a priority value associated with a number higher than the lower number. Thus in an aspect, if a matrix include 500 terms, the term can be associated with a priority value of 1-500, with 1 being the highest priority value and 500 being the lowest priority value, and with 1 being associated with the term having the lowest number of tags and 500 being associated with the term having the greatest number of tags. In another aspect, terms can be grouped into priority value associations. For example, a terms having 5-10 tags can be given a first and highest priority value, terms having 11-15 tags can be given second highest priority value, terms having 16-20 tags can be given a third highest priority value, terms having 21-25 tags can be given a fourth highest priority value, terms having 26-30 tags associated therewith can be given a fifth highest priority value, and etc.

In an embodiment, the matrix formation component 130 is further configured to remove the term from the matrix in response to an assignment of a term priority value that is lower than a predetermined threshold value. For instance, with respect to the above example, the matrix formation component 130 may remove a term from the matrix that are below a fifth highest priority value, or that have over 30 tags associated therewith.

Although system 100 has been generally described with reference to the receipt of a single term, the collection of tags for the term and subsequent processing of the term for association of the term with the tags in a matrix, it should be appreciated that system 100 is configured to process a plurality of terms. In fact, a matrix is generally more useful the greater the number of terms is defines. Thus it should be appreciated that the tag finder component is configured to receive a plurality of terms and query the one or more networked data sources to identify respective usages of the plurality of terms and one or more tags respectively assigned to the plurality of terms in association with the respective usages of the plurality of terms. The tag extraction component 120 is further configured to extract the one or more tags respectively assigned to the plurality of terms in association with the respective usages of the plurality of terms, and the matrix formation component 130 is further configured to associate each of the plurality of terms with the one or more tags respectively assigned to the other terms in association with the respective usages of the other terms, in the data matrix.

In an embodiment, the matrix formation component 130 is further configured to assign a tag priority value to a tag in the data matrix based in part on a total number of terms associated with the tag in the data matrix or based in part on a total number of terms associated with the tag in the data matrix with respect to other tags in the data matrix. According to this embodiment, the number of terms associated with a tag inversely reflects a tags priority value. For example, in an aspect, the greater the number of terms associated with a tag the lower its priority value. In other words, a low number of associated terms equates to a high tag priority value. In an aspect, tags can be grouped into priority value associations. For example, a tags having 5-10 terms associated therewith can be given a first and highest priority value, tags having 11-15 terms can be given second highest priority value, tags having 16-20 terms can be given a third highest priority value, tags having 21-25 terms can be given a fourth highest priority value, tags having 26-30 terms associated therewith can be given a fifth highest priority value, and etc.

In an embodiment, the matrix formation component 130 is further configured to remove a tag from the matrix in response to an assignment of a tag priority value that is lower than a predetermined threshold value. For instance, with respect to the above example, the matrix formation component 130 may remove a tag from the matrix that is assigned a tag priority value below a fifth highest priority value, or that has over 30 terms associated therewith.

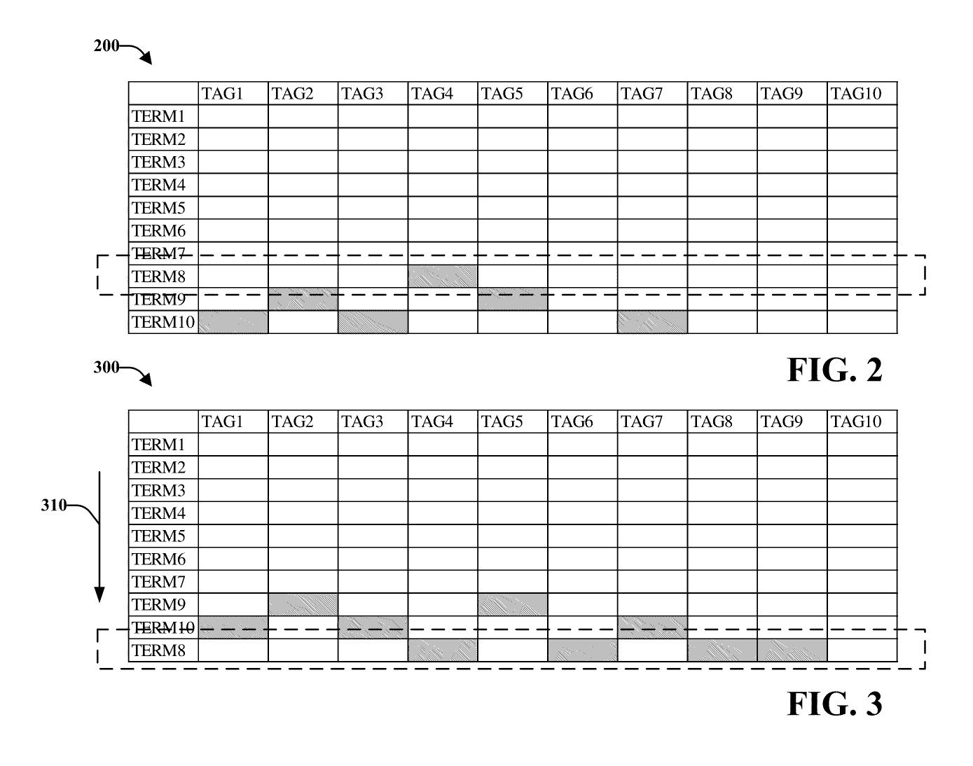

With reference back to the Figures, FIGS. 2-6 present depictions of matrices in accordance with one or more embodiments disclosed herein. FIGS. 2-6, depict matrices 200, 300, 400, 500, and 600. Each of matrices 200-600 are depicted as spreadsheets comprising ten rows and ten columns. Each of the rows correspond to a term value and each of the columns correspond to a tag value. In particular, the rows correspond to TERMS 1-10 and the columns correspond to TAGS 1-10. It should be appreciated that the labeling of terms and tags in matrices 200-600 is arbitrary. For example, the terms and tags can employ any labeling scheme, including names, number, letters, colors, and etc. It should be also be appreciated that matrices 200-300 are depicted with ten terms and ten tags for exemplary purposes. It should understood that a matrix in accordance with the subject disclosure can include any number N of terms and any number M of tags, where N and M are integers. Further, N can be greater than M, equal to M or less than M.

Referring to FIG. 2, presented is matrix 200. As seen in matrix 200, TERM8, TERM9, and TERM10 each are associated with tags as indicated by the darkened blocks. In particular, TERM8 is associated with a single tag, TAG4, TERM9 is associated with two tags, TAG2 and TAG5, and TERM10 is associated with three tags, TAG1, TAG3, and TAG7. Further, as seen in FIG. 2, TERM8 is located above TERM9 and TERM9 is located above TERM10. It should be appreciated that the labeling of the terms as TERMS 1-10 is not intended to reflect the term priority order. For example, TERM8 could correspond to the term “vampire,” TERM9 could correspond to the term “dinosaur,” and TERM10 could correspond to the term “horse.” However, a terms priority value or order is reflected in matrix 200 (and matrices 300-600) by its position in the matrix, where the lower the terms position, the lower the terms priority order. Thus in matrix 200, TERM8 has a higher priority value than TERM9, and TERM9 has a higher priority value than TERM10. This is because TERM8 has the lowest number of tag associations (one), TERM9 has two tag associations, and TERM10 has the highest number of tag associations (three).

FIG. 3 presents matrix 300. Matrix 300 is an updated matrix 200. In particular, matrix 300 depict matrix 200 following the finding and extraction of additional tags associated with TERM8 in one or more data sources. As seen in FIG. 3, in addition to TAG4, TERM8 is further associated with TAG6, TAG8, and TAG9. In matrix 300, TERM8 is shifted downward, in accordance with the direction of arrow 310, to the bottom of the matrix. Therefore TERM8 in matrix 300 has the lowest priority value. This is because TERM8 is now associated with four tags while TERM9 and TERM10 are associated with three tags and two tags respectively.

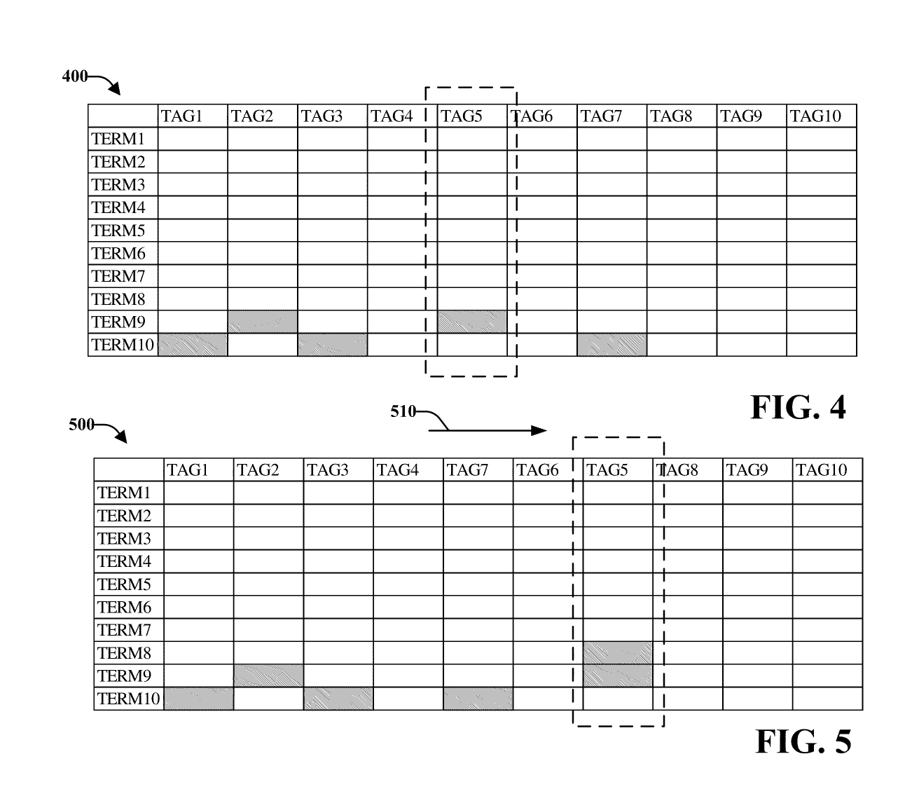

Referring to FIG. 4, presented is matrix 400. As seen in matrix 400, TAG1, TAG2, TAG4, TAG5, and TAG7 each are associated with terms as indicated by the darkened blocks. In particular, TAG2 is associated with TERM9 and TAG5 is associated with TERM9 while TAG1, TAG3, and TAG7 are associated with TERM10. It should be appreciated that the labeling of the tags as TAGS 1-10 is not intended to reflect the tag priority order. For example, TAG1 could correspond to the tag “blood,” TAG2 could correspond to the tag “dark,” TAG3 could correspond to the tag “fangs,” TAG4 could correspond to the tag “death,” and so on. However, a terms priority value or order is generally reflected in matrix 400 (and matrices 300-600) by its position in the matrix, where in general, the lower the tags position, the lower the tags priority order. However, as seen in matrix 400, each of TAG1, TAG2, TAG4, TAG5, and TAG7 are associated with a single term, TERM8 or TERM9. Therefore, in essence, each of TAG1, TAG2, TAG4, TAG5, and TAG7 have equal priority values. However for purposes of ease of depiction of the matrix, matrix 400 depicts TAG1, TAG2, TAG4, TAG5, and TAG7 in different positions. In an aspect, matrices 200-600 can be represented in three dimensions (although only depicted in two-dimensions). According to this aspect, TAG1, TAG2, TAG4, TAG5, and TAG7 can be depicted in a same position in a third dimension, where such same position represents a priority value.

FIG. 5 presents matrix 500. Matrix 500 is an updated matrix 400. In particular, matrix 500 depicts matrix 400 following the finding and extraction of TAG5 with respect to TERM8 in one or more data sources. As seen in FIG. 5, TAG5 is thus associated with both TERM8 and TERM9. Thus in matrix 500, TAG5 is shifted downward (to the right), in accordance with the direction of arrow 510, toward the bottom of the matrix. Therefore TAG5 in matrix 500 has the lowest priority value. This is because TAG5 is now associated with two tags while TAG1, TAG2, TAG3 and TAG7 are associated with only one term respectively. It should be appreciated that matrices 400 and 500 are merely presented to depict the shifting of tags within a matrix and that matrices 400 and 500 are not accurate representations of all aspects of a matrices described herein. For example, because TAGS8-9 are not depicted as associated with any terms, they should essentially be located at the top of the matrix (or to the left in the opposite direction of arrow 510). In an aspect, as noted above, in order to account for multiple overlap in location within the matrix, matrixes can be visualized and/or represented in three dimensions.

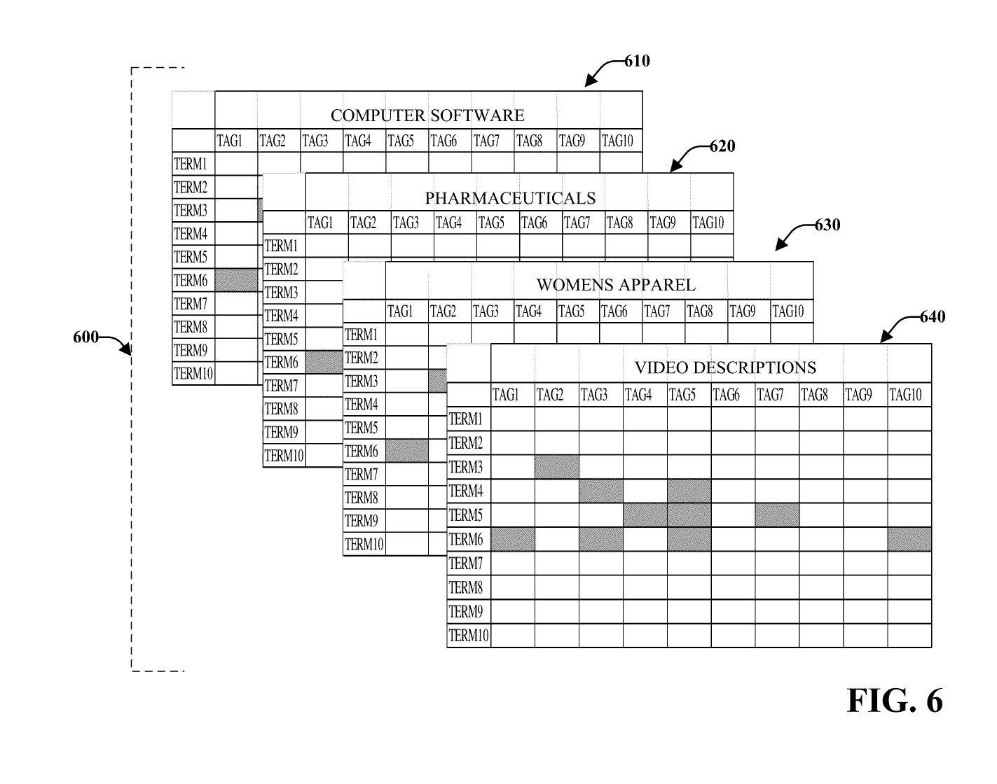

FIG. 6 present matrices 600. In particular, as noted above, in an aspect, system 100 (and additional systems described herein, can generate a plurality of different matrices that represent associations of terms to tags under a given context of usage. For example, matrices 600 include four matrices, matrix 610, matrix 620, matrix 630, and matrix 640. Each of matrix 610, matrix 620, matrix 630, and matrix 640 represent matrices for different content usage categories or contexts of usage. For example, matrix 610 presents a matrix that associates terms to tags with respect to usage in video descriptions. Matrix 620 presents a matrix that associates terms to tags with respect to usage in women's apparel merchandise. Matrix 630 presents a matrix that associates terms to tags with respect to usage in pharmaceutical descriptions, and matrix 640 presents a matrix that associates terms to tags with respect to usage in computer software descriptions.

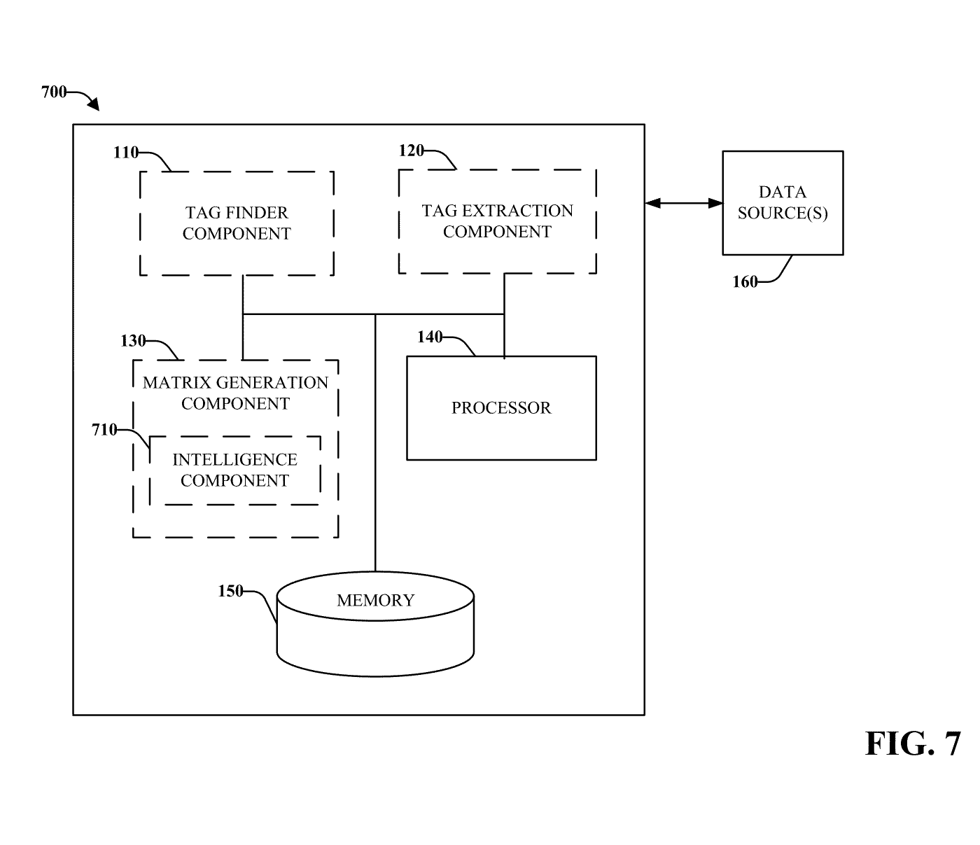

Turning now to FIG. 7, presented is another non-limiting embodiment of a system 700 that facilitates generating a matrix in accordance with one or more embodiments. System 700 can include intelligence component 710. Intelligence component 710 can provide for or aid in various inferences or determinations. For example, all or portions of tag finder component 110, tag extraction component 120 and matrix generation component 130 can be operatively coupled to intelligence component 710. Additionally or alternatively, all or portions of intelligence component 710 can be included in one or more components described herein. Moreover, intelligence component 710 may be granted access to all or portions of media items, and external networks and data sources 160 described herein.

In an aspect, intelligence component 110 can infer what data sources to explore when searching for terms as well as where to search for the key terms within those data sources. For example, the intelligence component 110 can infer the subject matter in which a term may be used and relate the term to those data sources that specialize in the subject matter. In another aspect, the tag finder component can infer data sources that may have accurate and strong tags for key terms based reputation of the data sources and or traffic associated with the data sources. Further matrix generation component 130 may employ intelligence component 710 when generating one or more matrices. For example, the matrix generation component 710 may infer the best tag candidates to associate with terms in the matrix based on learned benefits of the association with respect to the tag assignment to the term in the one or more data sources. For example, the intelligence component 710 may infer that a certain tag X is responsible for the most accurate identification of an item with respect to various search engines. Accordingly, the intelligence component 710 can facilitate the matrix generation component when associating the “best” tags in the matrix and when assigning priority values to tags.

In order to provide for or aid in the numerous inferences described herein (e.g., inferring characteristics of media items and inferring end credit transition points), intelligence component 710 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority. Any of the foregoing inferences can potentially be based upon, e.g., Bayesian probabilities or confidence measures or based upon machine learning techniques related to historical analysis, feedback, and/or other determinations or inferences.

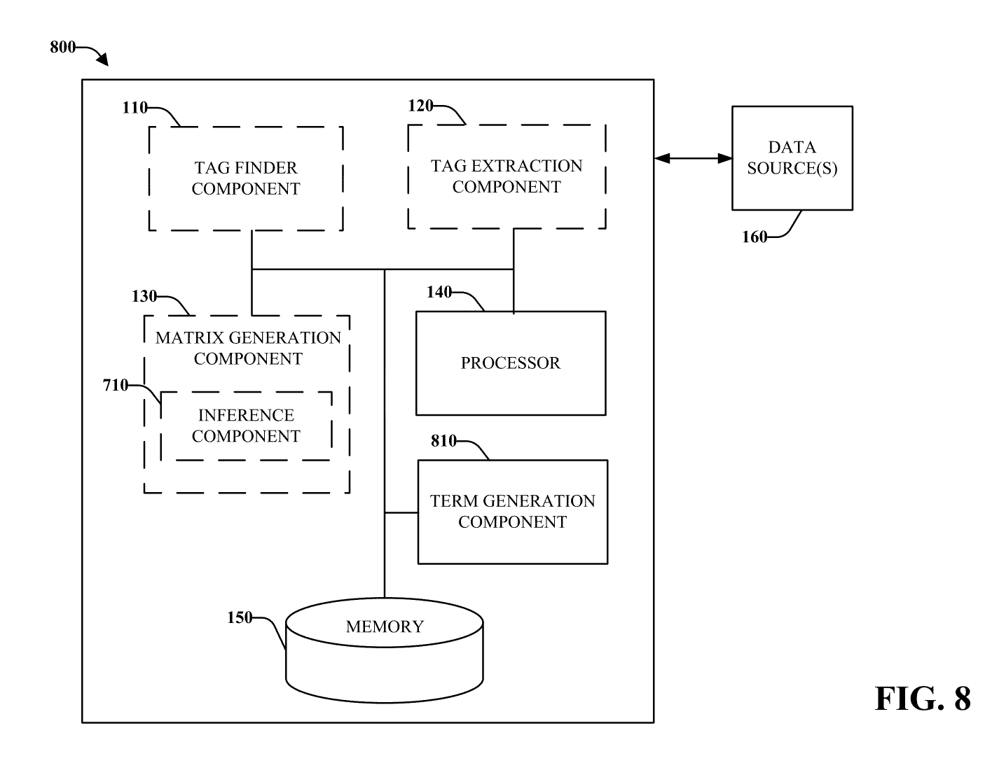

Turning now to FIG. 8, presented is another non-limiting embodiment of a system 800 that facilitates generating a matrix in accordance with one or more embodiments. System 800 can include term generation component 810 that generates a subset of terms from a description comprising a plurality of terms. In particular, the term generation component 810 can receive a description comprising a plurality of words or terms, some of which have greater input meaning than others with respect to representing key features of the item the description is describing. The term generation component 810 filters the plurality of terms for a description to generate a subset of the terms that have the greatest input meaning.

For example, suppose a film synopsis or description is as follows: Forty years ago, Harriet Vanger disappeared without a trace on the island owned by the powerful Vanger clan. Her body was never found, but her uncle is convinced it's murder and the murderer is a member of his own, is closely knit and dysfunctional families. He hires a disgraced journalist Mikael Blomqvist and Lisbeth Salander tattooed hakershu to investigate. The term generation component 810 breaks the text up into separate words/terms and eliminates generic words via one or more filters (e.g. Forty, Years, Ago, etc.) and establishes collection of search words. Then term filter component 110 can take each word from the collection of search words and quire one or more external data sources to find other films, which synopsis includes the words from the collection of search words. A subset of terms, (or collection of search terms), can include one or more terms. Once a subset of terms is generated, the term generation component 810 can provide the terms in the subset to the term finder component 110 for querying.

The term generation component 810 can apply a variety of filters to a description in order to generate an effective candidate set of terms for description tags. In an aspect, the term generation component 810 filters terms of a description as a function of term type. Term type refers to a classification of a type of word with respect to the parts of speech. For example, in for a description in the English language, a type of word can include: article, noun, pronoun, adjective, verb, adverb, preposition, conjunction, and interjection. According to this aspect, the term generation component 810 can be configured to filter out word type such that the subset of words does not include that word type. For example, the term generation component 810 may filter out articles, prepositions and/or conjunctions from a plurality of description words/terms. In another example, the term generation component 810 may filter or all words aside from nouns.

In another aspect, the term generation component 810, can filter a description as a function of character length. For instance, the character length filter can represent a general correlation between length of a word/term and the complexity and weight of the term with respect to providing substantive and distinctive information about the description as a whole. According to this aspect, the term generation component 810 can apply a minimum character limit as a filter. For example, the term generation component 810 may filter out all terms having four characters or less. In another aspect, the term generation component 810 can apply a filter that recognizes names and filters a description so that names are included in the subset. For example, the term generation component can apply a filter that includes a five character minimum yet also includes an exception for names that are four characters or less.

In yet another aspect, the term generation component 810 can filter a description based on definitions of terms provided in a reference dictionary. In particular, system 800 can include a reference dictionary provided in memory or in a remote data store that can be accessed by term generation component 810. The reference dictionary can provide definitions of terms that define a value of a term. For example, the reference dictionary can include a list of terms and associate each term with a score. According to this example, the score can be the definition of the term. In general, generic terms can be defined with lower scores than non-generic terms. For example, the term “fun” may be defined as generic and thus be associated with a low score. The definitions may also include literal definitions of the terms. According to this aspect, the term generation component 810 may filter out terms that are defined with a score lower than a predetermined threshold. As a result, the term generation component 810 can filter out terms from a description that are defined by the system, per a reference dictionary, as generic.

Still in yet another aspect, the term generation component 810 can apply a filter that captures words that occur more than once in a description so that they are included in the subset. For example, a description may include the word “fate” twice. Although the term generation component 810 may apply a filter that eliminates words having four characters or less, the term generation component 810 may also apply an exception that keeps words appearing more than once. In an aspect, the threshold for appearing more than once can include terms that are substantially similar. For example, a term in a singular form or a plural form can be counted as a same term. In another example, a term that is modified into different types can also be counted as a same term for purposes of counting. Thus according to this example, the term “murder” and “murderer” within the same description can equate to a duplication of a term.

The term generation component 810 is further configured to filter terms based on language. In an aspect, the term generation component can identify a language of a description prior to filtering the description. The term generation component 810 can further apply the appropriate filters that account for the language of the terms. Further, it should be appreciated that the above described filters are merely examples of possible filters to apply to a description comprising a plurality of terms in order to effectively reduce the description to a subset of key terms best representative of the distinguishing characteristics of the item the description represents.

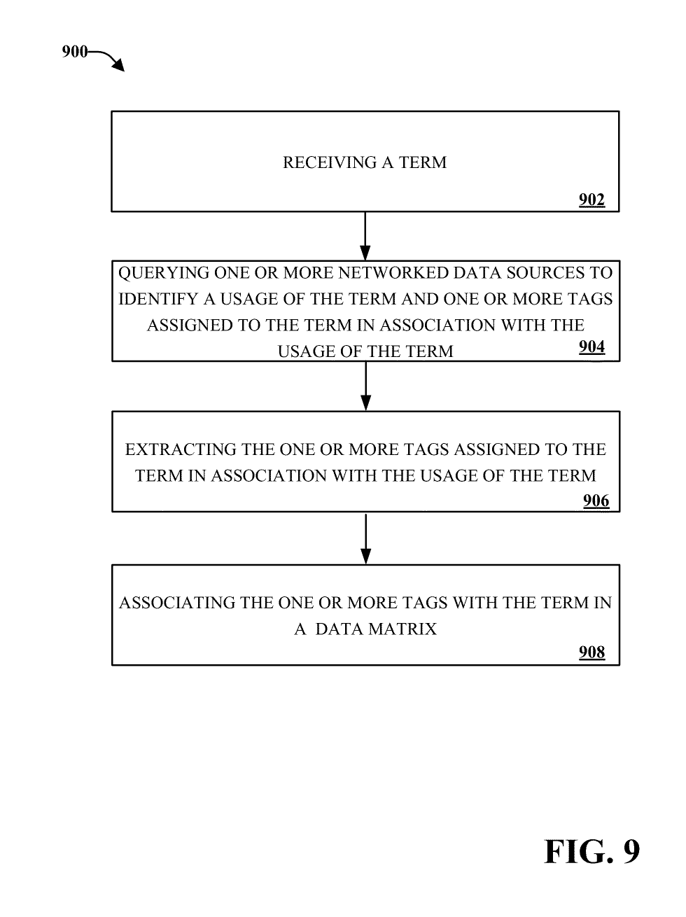

FIGS. 9-11 and 13 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 9, presented is a flow diagram of an example application of systems disclosed in this description accordance with an embodiment. In an aspect, exemplary methodology 900, a matrix generation system is stored in a memory and utilizes a processor to execute computer executable instructions to perform functions. At 902, a term is received. For example, the term can be manually provided by a user, computer generated from a list, or computer generated via term generation component 810. At 904, one or more networked data sources are queried to identify a usage of the term and one or more tags assigned to the term in association with the usage of the term. For example, a data source that provides movie descriptions may use the term “vampire” to describe a certain movie and assign keyword tags “blood,” “dark,” and “fangs,” to the term. At 906, the one or more tags assigned to the term in association with the usage of the term are extracted. In particular, the one or more terms can be extracted and stored in temporary memory for processing by the matrix generation component. Then at 908, the one or more tags are associated with the term in a data matrix.

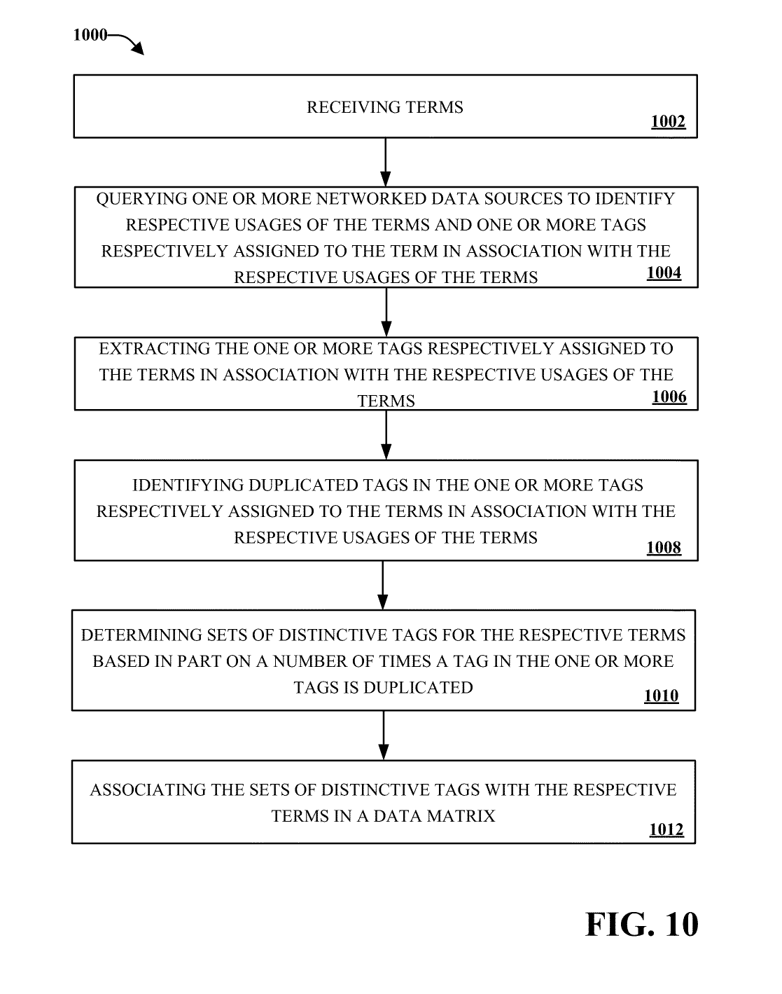

Referring now to FIG. 10, presented is a flow diagram of an example application of systems disclosed in this description accordance with an embodiment. In an aspect, exemplary methodology 1000, a matrix generation system is stored in a memory and utilizes a processor to execute computer executable instructions to perform functions. At 1002, term are received. In an aspect, the term finder component 110 can receive multiple terms at one time and conduct querying for those terms at the same time.

In another aspect, the term finder component 110 can receive terms and carry out a query for each of the terms individually before proceeding to a next term. At 1002, one or more networked data sources are queried to identify respective usages of the terms and one or more tags respectively assigned to the terms in association with the respective usages of the terms. At 1006, the one or more tags respectively assigned to the terms in association with the respective usages of the terms are extracted. At 1008, duplicated tags in the one or more tags respectively assigned to the terms in association with the respective usages of the terms are identified. At 1010 sets of distinctive tags for the respective terms are determined based in part on a number of times a tag in the one or more tags is duplicated. Then at 1012, the sets of distinctive tags are associated with the respective terms in the data matrix.

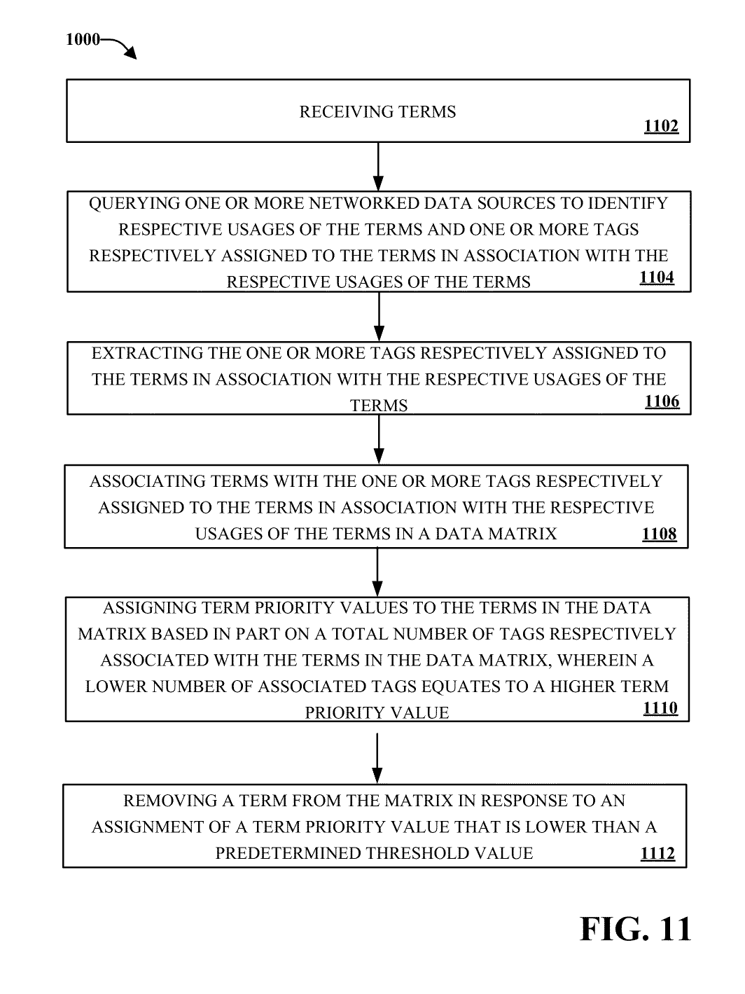

Referring now to FIG. 11, presented is a flow diagram of an example application of systems disclosed in this description accordance with an embodiment. In an aspect, exemplary methodology 1100, a matrix generation system is stored in a memory and utilizes a processor to execute computer executable instructions to perform functions. At 1102, term are received. In an aspect, the term finder component 110 can receive multiple terms at one time and conduct querying for those terms at the same time. In another aspect, the term finder component 110 can receive terms and carry out a query for each of the terms individually before proceeding to a next term. At 1002, one or more networked data sources are queried to identify respective usages of the terms and one or more tags respectively assigned to the terms in association with the respective usages of the terms. At 1006, the one or more tags respectively assigned to the terms in association with the respective usages of the terms are extracted. At 1008, the terms are associated with the one or more tags respectively assigned to the terms in association with the respective usages of the terms, in the data matrix. At 1110, term priority values are assigned to the terms in the data matrix based in part on a total number of tags respectively associated with the terms in the data matrix, wherein a lower number of associated tags equates to a higher term priority value. Then at 1112, a term is removed from the matrix in response to an assignment of a term priority value that is lower than a predetermined threshold value.

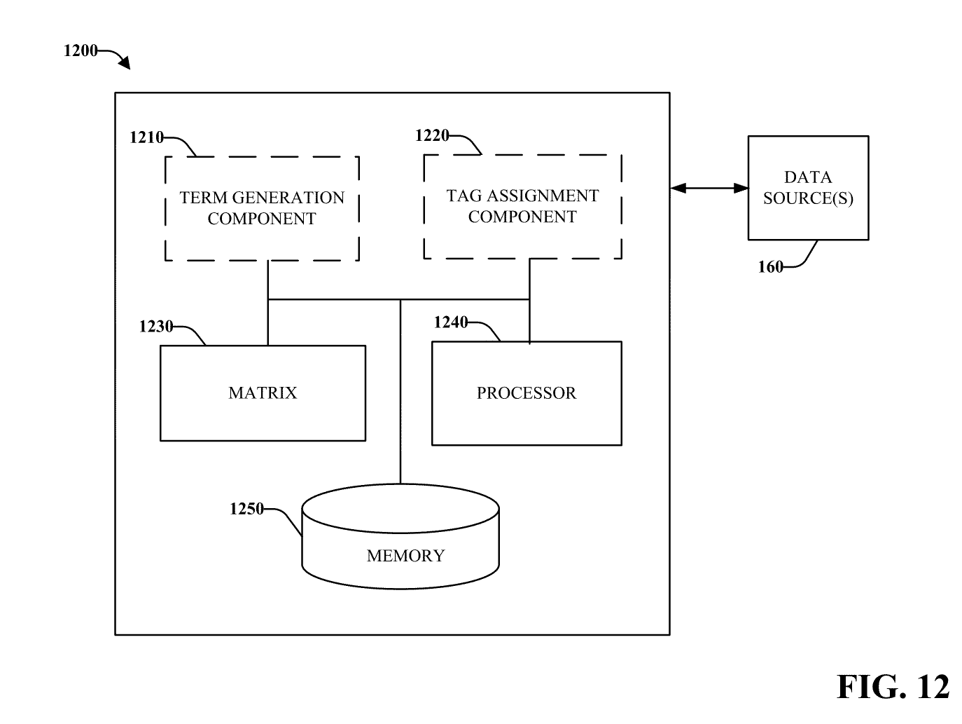

Looking now at FIG. 12, presented is a system 1200 than can facilitates employing a matrix, as described herein, in order to automatically assign tags to item descriptions. System 1200 can include memory 1250 for storing computer executable components and instructions. A processor 1240 can facilitate operation of the computer executable components and instructions by the system 100. Systems 100, 700, and 800 as described herein are configured to generate a matrix that maps known words or terms to one or more tags based on pre-existing tag assignments for the known terms in a similar usage context. For example, a matrix as described herein can map known words or terms to one or more tags based on pre-existing tag assignments for the known terms with respect to movie descriptions, clothing descriptions, pharmaceutical descriptions and etc. Matrices generated by systems disclosed herein can then later be employed by system 1200 to automatically determine tag assignments for new information that has not yet been tagged.

Although matrix generation systems (systems 100, 700, and 800) are depicted as separate or different systems from tag assignment system 1200, it should be appreciated that such systems can be combined into a single system. In addition, although matrix component 1230 is depicted as internal to system 1200, it should be appreciated that matrix component 1230, and additional matrices generated in accordance with the subject disclosure, can be associated with or made accessible to other systems and devices. For example matrix component 1230 can be associated with or stored in memory 1250. In another example, matrix component 1230 can be stored remotely from system 1200 and accessed by system 1200 via a network.

In an aspect, system 1200 can include term generation component 1210, tag assignment component 1220, and matrix component 1230. Matrix component 1230 is configured to store one or more matrices as described in accordance with embodiments disclosed herein. In particular, matrix component stores one or more matrices that map terms to tags as a function of pre-existing associations between the terms and the tags in one or more external data sources 160. Term generation component 1210 is configured to receive a description comprising a plurality of terms and filter the description to identify a subset of the plurality of terms. In particular, term generation component 1210 can perform in a same or similar manner as term generation component 810. Tag assignment component 1220 is configured to identify one or more tags associated with the subset of the plurality of terms in a data matrix associated with matrix component 1230 and assign the one or more tags to the description.

Term generation component 1210 generates a subset of terms from a description comprising a plurality of terms. In particular, the term generation component 1210 can receive a description comprising a plurality of words or terms, some of which have greater input meaning than others with respect to representing key features of the item the description is describing. The term generation component 810 filters the plurality of terms for a description to generate a subset of the terms that have the greatest input meaning. In particular, the term generation component 1210 breaks the text of an item description up into separate words/terms, eliminates generic words via one or more filters, and establishes collection of keywords. Then tag assignment component 1220 takes the collection of keywords and finds one or more tags to assign to the respective keywords as identified in a data matrix.

The term generation component 1210 can apply a variety of filters to a description in order to generate an effective candidate set of terms for description tags. In an aspect, the term generation component 1210 filters terms of a description as a function of term type. In another aspect, the term generation component 1210, can filter a description as a function of character length. In another yet aspect, the term generation component 1210 can apply a filter that recognizes names and filters a description so that names are included in the subset. For example, the term generation component can apply a filter that includes a five character minimum yet also includes an exception for names that are four characters or less. In another aspect, the term generation component 1210 can apply a filter that captures words that occur more than once in a description so that they are included in the subset.

In yet another aspect, the term generation component 1210 can filter a description based on definitions of terms provided in a reference dictionary. In particular, system 1200 can include a reference dictionary provided in memory 1250 or in a remote data store that can be accessed by term generation component 1210. The reference dictionary can provide definitions of terms that define a value of a term. For example, the reference dictionary can include a list of terms and associate each term with a score. According to this example, the score can be the definition of the term. In general, generic terms can be defined with lower scores than non-generic terms. For example, the term “fun” may be defined as generic and thus be associated with a low score. The definitions may also include literal definitions of the terms. According to this aspect, the term generation component 1210 may filter out terms that are defined with a score lower than a predetermined threshold. As a result, the term generation component 1210 can filter out terms from a description that are defined by the system, per a reference dictionary, as generic.

In a similar aspect the term generation component 1210 is configured to filter the description as a function of a priority value associated with a term in the data matrix. For example, as discussed supra, the data matrix can associate terms with a priority value based on a number of a total number of tags associated with the terms in the data matrix, and/or based on a number of tags associated with the terms in the data matrix with respect to other terms. According to this aspect, a lower number of associated tags equates to a higher tag priority value. Similarly, the higher the tag priority, the less generic or the more unique, a term generally is deemed by the system. Thus in an aspect, the term generation component 1210 can employ term priority values as defined by a matrix to identify the most unique terms found in a description. In an aspect, the term generation component 1210 can apply a minimum threshold value for a term's priority value as a filter. For example, the term generation component 1210 can filter out terms from a description that have a priority value below a specified value, such as below the top ten percent.

The term generation component 1210 is further configured to filter terms based on language. In an aspect, the term generation component can identify a language of a description prior to filtering the description. The term generation component 1210 can further apply the appropriate filters that account for the language of the terms. Further, it should be appreciated that the above described filters are merely examples of possible filters to apply to a description comprising a plurality of terms in order to effectively reduce the description to a subset of key terms best representative of the distinguishing characteristics of the item the description represents.

Once the term generation component 1210 has generated a subset of key terms for a description, the tag assignment component 1220 assigns tags to each of the key terms by employing a matrix as described herein. In particular, the tag assignment component 1220 can automatically generate a metadata document that includes tag assignment for a received description, wherein the tag assignments are based off of the defined associations between each of the terms of a subset and tags in the data matrix. In an aspect, the tag assignment component is configured to identify the content category of a received description and select an appropriate matrix to employ based on the content category. For example, if the description is a synopsis for a movie, the matrix component can select a matrix from matrix component 1230 that associates terms with tags with respect to movie descriptions. In another aspect, the tag assignment component can apply a general matrix that associated tags to terms for a variety of content categories.

In an aspect, tag assignment component 1220 can identify the one or more tags associated with the subset of the plurality of terms in the data matrix based on a priority value associated with the one or more tags in the data matrix. In particular, as discussed supra, a matrix can define priority values for tags based on a number of terms a tag is associated with. In an aspect, a data matrix can assign a priority values to a tags based in part on a number of times the tag is associated with the terms in the one or more external data sources. For example, as discussed supra, the matrix generation component 130 may only associate tags with terms in a matrix when they are duplicated at least twice in one or more external data sources. According to this aspect, the matrix generation component 130 may chose to associate only the tags that have a specific duplication number or the top ten tags having the highest duplication numbers and etc. Therefore, according to this aspect, a matrix may only include tags having high duplication numbers. Thus in an aspect, the matrix can indirectly and/or directly associate a priority value with certain tags in the matrix based on the tags duplication number for a given term.

In another aspect, the tag assignment component is further configured to identify one or more tags associated with the subset of the plurality of terms in the data matrix based on a priority value associated with the one or more tags in the data matrix, wherein the data matrix further assigns priority values to the tags based in part on a total number of terms associated with the tags in the data matrix, wherein a lower number of associated terms equates to a higher tag priority value. According to this aspect, as tags become associated with more and more terms in a data matrix, the tags priority value is lowered. The lowering of the tags priority value in the matrix indicates that tag has a high affiliation with many terms and thus is generic. When a tag becomes generic, as defined by a threshold tag priority value by the system, the tag assignment component can choose not to associate the tag with a term. Thus for example, the tag assignment component may identify the top three tags having the highest priority values for a given term in the subset and associate those top three tags with the term.

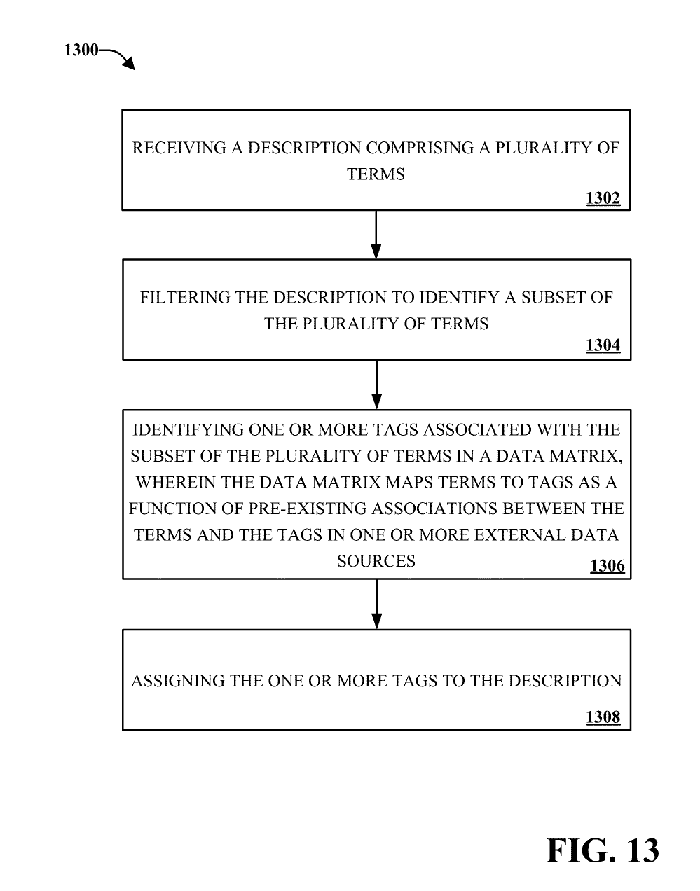

Referring now to FIG. 13 presented is a flow diagram of an example application of systems disclosed in this description accordance with an embodiment. In an aspect, exemplary methodology 1300, a tag assignment system is stored in a memory and utilizes a processor to execute computer executable instructions to perform functions. At 1302, a description comprising a plurality of terms is received. At 1304, the description is filtered to identify a subset of the plurality of terms. For example, the description can be filtered to eliminate words that have weak input meaning, such as articles or generic words. At 1306, one or more tags associated with the subset of the plurality of terms in a data matrix are identified, wherein the data matrix maps terms to tags as a function of pre-existing associations between the terms and the tags in one or more external data sources. Lastly, at 1308 the one or more tags are assigned to the description.

### EXAMPLE OPERATING ENVIRONMENTS

One of ordinary skill in the art can appreciate that the various non-limiting embodiments of matrix generation and matrix utilization and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the matrix generation and matrix utilization as described for various non-limiting embodiments of the subject disclosure.

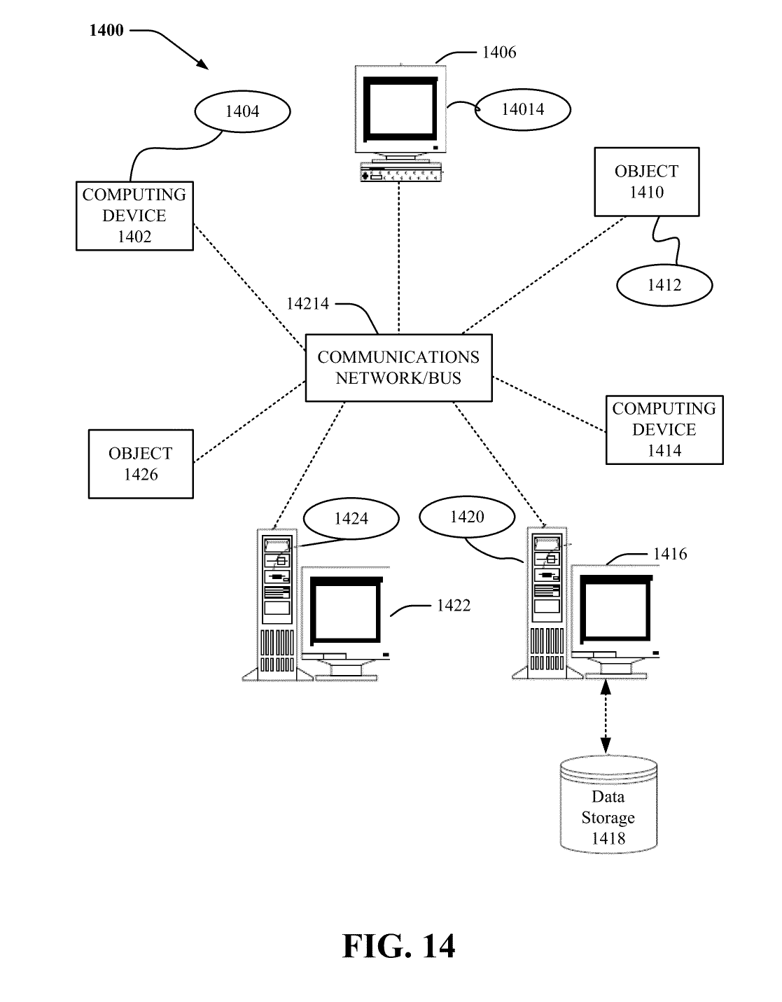

FIG. 14 provides a schematic diagram of an exemplary networked or distributed computing environment. The distributed computing environment comprises computing objects 1422, 1416, etc. and computing objects or devices 1402, 1406, 1410, 1426, 1414, etc., which may include programs, methods, data stores, programmable logic, etc., as represented by applications 1404, 1418, 1412, 1424, 1420. It can be appreciated that computing objects 1422, 1416, etc. and computing objects or devices 1402, 1406, 1410, 1426, 1414, etc. may comprise different devices, such as personal digital assistants (PDAs), audio/video devices, mobile phones, MP3 players, personal computers, laptops, etc.

Each computing object 1422, 1416, etc. and computing objects or devices 1402, 1406, 1410, 1426, 1414, etc. can communicate with one or more other computing objects 1422, 1416, etc. and computing objects or devices 1402, 1406, 1410, 1426, 1414, etc. by way of the communications network 1426, either directly or indirectly. Even though illustrated as a single element in FIG. 14, communications network 1426 may comprise other computing objects and computing devices that provide services to the system of FIG. 14, and/or may represent multiple interconnected networks, which are not shown. Each computing object 1422, 1416, etc. or computing object or device 1402, 1406, 1410, 1426, 1414, etc. can also contain an application, such as applications 1404, 1418, 1412, 1424, 1420, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 14, as a non-limiting example, computing objects or devices 1402, 1406, 1410, 1426, 1414, etc. can be thought of as clients and computing objects 1422, 1416, etc. can be thought of as servers where computing objects 1422, 1416, etc., acting as servers provide data services, such as receiving data from client computing objects or devices 1402, 1406, 1410, 1426, 1414, etc., storing of data, processing of data, transmitting data to client computing objects or devices 1402, 1406, 1410, 1426, 1414, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1426 or bus is the Internet, for example, the computing objects 1422, 1416, etc. can be Web servers with which other computing objects or devices 1402, 1406, 1410, 1426, 1414, etc. communicate via any of a number of known protocols, such as the hypertext transfer protocol (HTTP). Computing objects 1422, 1416, etc. acting as servers may also serve as clients, e.g., computing objects or devices 1402, 1406, 1410, 1426, 1414, etc., as may be characteristic of a distributed computing environment.

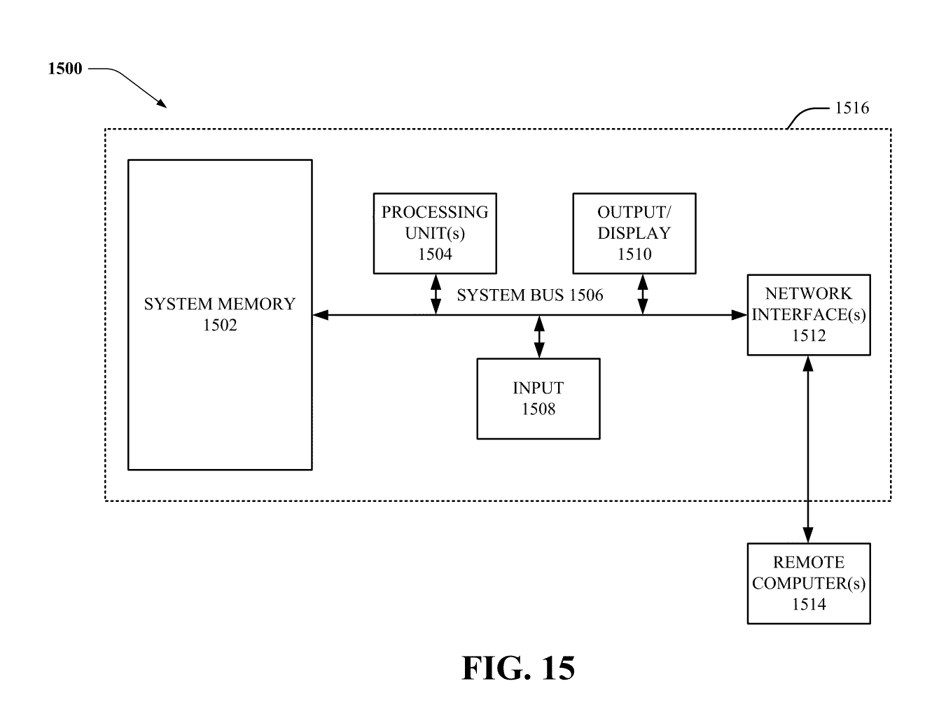

As mentioned, advantageously, the techniques described herein can be applied to any device where it is desirable to facilitate matrix generation and matrix utilization. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 15 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 15 thus illustrates an example of a suitable computing system environment 1500 in which one or aspects of the non-limiting embodiments described herein can be implemented, although as made clear above, the computing system environment 1500 is only one example of a suitable computing environment and is not intended to suggest any limitation as to scope of use or functionality. Neither should the computing system environment 1500 be interpreted as having any dependency or requirement relating to any one or combination of components illustrated in the exemplary computing system environment 1500.

With reference to FIG. 15, an exemplary remote device for implementing one or more non-limiting embodiments includes a general purpose computing device in the form of a computer 1516. Components of computer 1516 may include, but are not limited to, a processing unit 1504, a system memory 1502, and a system bus 1506 that couples various system components including the system memory to the processing unit 1504.

Computer 1516 typically includes a variety of computer readable media and can be any available media that can be accessed by computer 1516. The system memory 1502 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1502 may also include an operating system, application programs, other program modules, and program data.

A user can enter commands and information into the computer 1516 through input devices 1508. A monitor or other type of display device is also connected to the system bus 1506 via an interface, such as output interface 1512. In addition to a monitor, computers can also include other peripheral output devices such as speakers and a printer, which may be connected through output interface 1512.

The computer 1516 may operate in a networked or distributed environment using logical connections to one or more other remote computers, such as remote computer 1512. The remote computer 1512 may be a personal computer, a server, a router, a network PC, a peer device or other common network node, or any other remote media consumption or transmission device, and may include any or all of the elements described above relative to the computer 1516. The logical connections depicted in FIG. 15 include a network, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described infra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
a memory having computer executable components stored thereon; and
a processor communicatively coupled to the memory, the processor configured to facilitate execution of the computer executable components, the computer executable components, comprising:
a term generation component configured to receive a description comprising a plurality of terms and filter the description to identify a subset of the plurality of terms; and
a tag assignment component configured to identify one or more tags associated with the subset of the plurality of terms in a data matrix and assign the one or more tags to the description, wherein the data matrix maps terms to tags as a function of pre-existing associations between the terms and the tags in one or more external data sources.

2. The system of claim 1, wherein the term generation component is configured to filter the description as a function of a term type.

3. The system of claim 1, wherein the term generation component is configured to filter the description as a function of a term length.

4. The system of claim 1, wherein the term generation component is configured to filter the description as a function of a definition of a term.

5. The system of claim 1, wherein the term generation component is configured to filter the description as a function of a priority value associated with a term in the data matrix, wherein the data matrix further assigns priority values to the terms based in part on a total number of tags associated with the terms in the data matrix, wherein a lower number of associated tags equates to a higher tag priority value than a priority value associated with a number higher than the lower number.

6. The system of claim 1, wherein the tag assignment component is further configured to identify the one or more tags associated with the subset of the plurality of terms in the data matrix based on a priority value associated with the one or more tags in the data matrix, wherein the data matrix further assigns priority values to the tags based in part on a number of times the tags are associated with the terms in the one or more external data sources.

7. The system of claim 6, wherein the priority value associated with the one or more tags in the data matrix indicates the one or more tags are associated with respective terms in the subset in the one or more external data sources at least twice.

8. The system of claim 1, wherein a tag assignment component is further configured to identify one or more tags associated with the subset of the plurality of terms in the data matrix based on a priority value associated with the one or more tags in the data matrix, wherein the data matrix further assigns priority values to the tags based in part on a total number of terms associated with the tags in the data matrix, wherein a lower number of associated terms equates to a higher tag priority value than a priority value associated with a number higher than the lower number.

9. The system of claim 1, wherein the data matrix maps the terms to the tags as a function of pre-existing associations between the terms and the tags with respect to a predefined content category, in the one or more external data sources.

10. The system of claim 1, wherein the data matrix maps the terms to the tags as a function of the pre-existing associations between the terms and the tags and as a function of at least one of new associations between the terms and the tags in the one or more external data sources or new associations between new terms and new tags in the one or more external data sources.

11. A method, comprising:
employing at least one processor executing computer executable instructions embodied on at least one non-transitory computer readable medium to perform operations comprising:
receiving a description comprising a plurality of terms;
filtering the description to identify a subset of the plurality of terms;
identifying one or more tags associated with the subset of the plurality of terms in a data matrix, wherein the data matrix maps terms to tags as a function of pre-existing associations between the terms and the tags in one or more external data sources; and
assigning the one or more tags to the description.

12. The method of claim 11, wherein the filtering comprises filtering the description as a function of a term type.

13. The method of claim 11, wherein the filtering comprises filtering the description as a function of a term length.

14. The method of claim 11, wherein the filtering comprises filtering the description as a function of a term definition.

15. The method of claim 11, wherein the filtering comprises filtering the description as a function of a priority value associated with a term in the data matrix, wherein the data matrix further assigns priority values to the terms based in part on a total number of tags associated with the terms in the data matrix, wherein a lower number of associated tags equates to a higher tag priority value than a priority value associated with a number higher than the lower No.

16. The method of claim 11, wherein the identifying further comprises identifying the one or more tags associated with the subset of the plurality of terms in the data matrix based on a priority value associated with the one or more tags in the data matrix, wherein the data matrix further assigns priority values to the tags based in part on a number of times the tags are associated with the terms in the one or more external data sources.

17. The method of claim 16, wherein the priority value associated with the one or more tags in the data matrix indicates the one or more tags are associated with respective terms in the subset in the one or more external data sources at least twice.

18. The method of claim 11, wherein the identifying further comprises identifying the one or more tags associated with the subset of the plurality of terms in the data matrix based on a priority value associated with the one or more tags in the data matrix, wherein the data matrix further assigns priority values to the tags based in part on a total number of terms associated with the tags in the data matrix, wherein a lower number of associated terms equates to a higher tag priority value than a priority value associated with a number higher than the lower number.

19. The method of claim 11, wherein the data matrix maps the terms to the tags as a function of pre-existing associations between the terms and the tags with respect to a predefined content category, in the one or more external data sources.

20. The method of claim 11, further comprising:
mapping the terms to the tags in the data matrix as a function of the pre-existing associations between the terms and the tags and as a function of at least one of new associations between the terms and the tags in the one or more external data sources or new associations between new terms and new tags in the one or more external data sources.

21. A computer-readable storage medium comprising computer-readable instructions that, in response to execution, cause a computing system to perform operations, comprising:
filtering a description of an item associated with a content category, the description comprising a plurality of terms;
determining a subset of terms from the plurality of terms based on the filtering;
identifying one or more tags associated with the subset of the plurality of terms in a data matrix, wherein the data matrix maps terms to tags as a function of pre-existing associations between the terms and the tags in one or more external data sources with respect to the content category; and
assigning the one or more tags to the description.
